(19) United States
(12) Patent Application Publication
(10) Pub. No.: US 2011/0290727 A1
(43) Pub. Date: Dec. 1, 2011

(54) Process for Preparing Membranes

(76) Inventor: Ronny Van Engelen, Tilburg (NL)

(21) Appl. No.: 13/145,097

(22) PCT Filed: Jan. 18, 2010
(86) PCT No.: PCT/GB2010/050066

§ 371 Date: Aug. 12, 2011

(30) Foreign Application Priority Data
Jan. 19, 2009 (EP) 09150878.8

(51) Int. Cl. C02F 1/44; C02F 1/46; H01M 10/44; B05D 3/06; H05H 1/24; B01D 39/16; C02F 1/469; H01M 8/10; C02F 101/10

(52) U.S. Cl. 210/650; 204/630; 204/665; 429/50; 429/491; 427/393.5; 427/569; 427/487; 210/506

(57) ABSTRACT

A process for preparing a composite membrane comprising the steps of:
(i) applying to a porous support having an average surface energy of 1 to 30 mN/m a composition having a viscosity of 1 to 5,000 mPa·s; and
(ii) increasing the viscosity of the composition to a value higher than 30,000 mPa·s within 30 seconds after the composition has been applied to the support;
   wherein the composition applied in step (i) has a surface tension that is at least 25 mN/m higher than the average surface energy of the porous support.

This invention relates to composite membranes, to a process for their preparation and to the use of such membranes.

Membranes are widely used in separation processes as selective barriers that allow certain chemical species to pass, i.e., the permeate, while retaining other chemical species, i.e., the retentate. Membranes having cationic or anionic charges are particularly useful for water purification and water softening. However the membranes need to be replaced regularly and are quite expensive. There is a need for efficient, mass production techniques for such membranes so that their price can be reduced.

Many membranes have low mechanical strength due to their thinness and require strengthening. One technique which has been used to provide the strengthening is to form the membrane by curing a curable liquid on a porous support. This technique suffers from problems, for example the curable liquid may pass completely through the porous support and foul the surface below the support. This problem is sometimes referred to as ‘strikethrough’.

U.S. Pat. No. 5,102,552 attempts to address the problem of ‘strikethrough’ by using a curable liquid of high viscosity. A UV curable liquid is applied to a microporous support and its high viscosity prevents the liquid from passing completely through the support. EP 321,241 used a similar technique. However application of highly viscous liquids to supports can be slow and troublesome due to the poor flow characteristics of viscous liquids.

In U.S. Pat. No. 5,126,189 the problem of ‘strikethrough’ was avoided by casting membranes onto a release paper and subsequently laminating the membrane onto a porous support.

WO 99/20378 describes the formation of composite membranes by a method comprising coating a hydrophilic polymer onto a hydrophobic support.

In U.S. Pat. No. 5,238,471 a thin film of an amorphous fluoropolymer was spray-deposited as an aerosol onto a microporous substrate to form a gas separation membrane. Subsequent thermal and/or chemical treatments were also required.

U.S. Pat. No. 3,912,834 and U.S. Pat. No. 5,593,738 address the problems of ‘strikethrough’ by casting the membrane on a porous support whose pores were already filled with a liquid.

In US2007/0007195 the problem of ‘strikethrough’ was addressed by using a porous substrate having very small pores. These pores were so small that molecules of the solution cannot penetrate into the support.

U.S. Pat. No. 6,454,986 describes the preparation of electret webs by a process in which a non-aqueous, polar liquid is applied to a web. The liquid may have a surface tension of at least 10 dynes per centimetre greater than the surface energy of the web. The liquids are simple solvents and do not increase in viscosity to any significant extent.

There is a need for a cost effective method for preparing composite membranes which can be used to mass produce the membranes with good mechanical strength which avoids or reduces ‘strikethrough’.

According to first aspect of the present invention there is provided a process for preparing a composite membrane comprising the steps of:
(i) applying to a porous support having an average surface energy of 1 to 30 mN/m a composition having a viscosity of 1 to 5,000 mPa·s; and
(ii) increasing the viscosity of the composition to a value higher than 30,000 mPa·s within 30 seconds after the composition has been applied to the support;
   wherein the composition applied in step (i) has a surface tension that is at least 25 mN/m higher than the average surface energy of the porous support.

From U.S. Pat. No. 5,102,552 one would expect that a curable composition having a viscosity below 35,000 mPa·s to generally pass through porous supports and foul the surfaces below. However using the method of the present invention one may apply compositions having much lower viscosities than those suggested as being essential in U.S. Pat. No. 5,102,552 while at the same time avoiding the problem of ‘strikethrough’.

In this specification the symbol > means “greater than” and the symbol < means “less than”.

The composition may be applied to the porous support by any suitable coating method, for example by curtain coating, blade coating, extrusion coating, air-knife coating, knife-over-roll coating, slide coating, nip roll coating, forward roll coating, reverse roll coating, dip coating, foulard coating, kiss coating, rod bar coating or spray coating. The coating of multiple layers of composition can be done simultaneously or consecutively. For simultaneous coating of multiple layers, curtain coating, slide coating, slot die coating and extrusion coating are preferred.

While it is possible to prepare the composite membrane by a batch-wise process using a stationary support, to gain full advantage of the invention it is preferred to prepare the membrane by a continuous process, e.g. by applying the composition to a moving support. Moving supports may be provided in a number of ways, for example the support may be in the form of a roll which is unwound continuously or the support may rest on a continuously driven belt (or a combination of these methods may be used). Using such techniques the composition may be applied to the support by a continuous process or it may be applied by a batch-wise process.

In a preferred embodiment multiple layers are coated simultaneously. Using multiple layers has distinct advantages: a so-called acceleration layer can be introduced to enable high speed coating and/or a top layer may be applied to create specific surface properties, without increasing the cost price of the membrane too much.

Thus in a preferred embodiment the process is a continuous process performed using a manufacturing unit comprising a composition application station, an irradiation source for increasing the viscosity of the composition, a membrane collecting station and a means for moving the support from the composition application station to the irradiation source and to the membrane collecting station. The composition application station may be located at an upstream position relative to the irradiation source and the irradiation source is located at an upstream position relative to the composite membrane collecting station.

In order to produce a sufficiently flowable composition for application by a high speed coating machine, it is preferred that the composition has a low surface tension, e.g. 45 mN/m or lower measured at 25° C., and a viscosity below 2000 mPa·s, more preferably 1 to 1000 mPa·s, especially 1 to 600 mPa·s, more especially 1 to 200 mPa·s, when measured at 25° C. at a shear rate of 40 s⁻¹. For coating methods such as slide bead coating the preferred viscosity is from 1 to 150 mPa·s, when measured at 25° C. at a shear rate of 40 s⁻¹. A low surface tension is preferred for good wetting and spreading, a low viscosity is preferred for high speed coating processes. Use of an acceleration layer having a very low viscosity is preferred to reduce the draw ratio of (visco-elastic) compositions to enhance coatability. A low viscosity also allows the use of low pressure in composition delivery systems (pressures from 1×10⁵ to 2.5×10⁵ Pa). Using low pressures in the line to the composition application station allows the application of standard filtration units and degassing stations to eliminate undesired particles and air bubbles, enabling defect free coatings.

With suitable coating techniques, the composition may be applied to a support moving at a speed of over 10 m/min, e.g. >15 m/min or even higher, such as 30 m/min, 60 m/min or up to 200 m/min, can be reached.

The surface energy of the support will largely depend upon its chemical composition and the nature of any treatments performed on the support. Polypropylene typically has a surface energy of about 30 mN/m, polyethylene about 35 mN/m, polyethyleneterephthalate about 45 mN/m and polyamide 6,6 about 47 mN/m. Polytetrafluoroethylene and polydimethylsiloxane have quite low surface energies of about 20 mN/m.

The surface energy (sometimes referred to as surface free energy) of many materials can be found at http://www.surface-tension.de/solid-surface-energy.htm and in ‘Properties of Polymers’ by D. W. van Krevelen, ISDN 9780080548197, 2009, CHAPTER 8, TABLE 8.2 page 235. Although there exist several methods to calculate the surface free energy from contact angle measurements, the preferred method for the purposes of this invention is the Fowkes method. Details of the Fowkes method can be found in F. M. Fowkes, J. Adhesion Sci. Tech., 1, 7-27 (1987).

The porous support preferably has an average surface energy of 1 to 30 mN/m, more preferably of or between 1 to 25 mN/m, especially 1 to 20 mN/m, more especially 1 to 15 mN/m, even more especially 2 to 10 mN/m.

In the Fowkes method, a drop of liquid with a known surface tension is placed on the surface whose energy is to be determined. The shape of the drop, specifically the contact angle, and the known surface tension of the liquid are the parameters which can be used to calculate the surface energy of the support. The liquid used for such experiments is referred to as the probe liquid, and several different probe liquids are used. In our experiments we used 3 or 4 different probe liquids to calculate the average surface energy, as described in the Examples.

The porous support may be obtained by treating conventional porous supports in such a manner as to achieve an average surface energy which is at least 25 mN/m lower than the surface tension of the composition to be applied thereto. For this purpose conventional supports to be treated may be a woven or non-woven synthetic fabric, e.g. polyethylene, polypropylene, polyacrylonitrile, polyvinyl chloride, polyester, polyamide, and copolymers thereof, or porous membranes based on e.g. polysulfone, polyethersulfone, polyphenylenesulfone, polyphenylenesulfide, polyimide, polyethermide, polyamide, polyamideimide, polyacrylonitrile, polycarbonate, polyacrylate, cellulose acetate, polypropylene, poly(4-methyl 1-pentene), polyinylidene fluoride, polytetrafluoroethylene, polyhexafluoropropylene, polychlorotrifluoroethylene, and copolymers thereof. Commercially available porous supports and strengthening materials are available commercially, e.g. from Freudenberg Vliesstoffe KG (Viledon Novatexx materials) and Sefar AG.

Most commercially available supports do not have a surface energy of 1 to 30 mN/m and will require a treatment to achieve this surface energy.

When the density of the support is very low, for example the porosity and/or pore size of the support is very large, the liquids applied thereto will often completely penetrate the support. Therefore the density of the support is preferably above 400 kg/m³ for a polyester nonwoven support, although the lower limit of density depends to some extent on the liquid being applied thereto, its viscosity, the size of pores, especially of the surface pores, the method of application and the thickness of the coating layer.

A suitable and easy method to determine the porosity of a support is air permeability. The preferred air permeability for the support is below 3,000 L/m².s, measured at a pressure of 2 mbar (200 Pa). Good results were obtained with supports having air permeability values of 0.01 to 2,500 L/m².s, especially 0.01 to 1,000 L/m².s. The preferred lower limit for air permeability depends to a large extent on the intended use of the composite membrane. For gas separation membranes, air fluxes of <0.1 L/m².s are sufficient to achieve good membrane properties, while for liquid treatment higher values are preferred, especially 100 to 1500 L/m².s, more especially 200 to 1000 L/m².s.

The porosity of the support expressed as average pore size is preferably between 0.01 and 100 μm. Particularly good results were obtained with supports having an average pore size of 40 to 60 μm, especially 52 μm. The porosity may be measured by the Porolux 1000 capillary flow porometer from Benelux Scientific, Belgium.

Conventional porous supports may be treated in such a manner as to achieve the desired average surface energy using a variety of techniques. For example one may treat a support with a fluoro compound and/or a silicon compound. Such treatments are preferably by wet chemical or plasma-coating techniques.

Wet chemical treatment processes generally comprise immersion of the support in a liquid (e.g. a fluid foam). Plasma coating techniques comprise applying an ionized gas to the support in the presence of an electrical charge, optionally in the presence of chemical compounds (e.g. fluoro or silicon compounds). In cold plasma treatments (e.g. room temperature), although the electron temperature can be much higher, the bulk temperature of the plasma is essentially the ambient temperature. Plasma can be obtained between electrodes using high frequency devices (typically 40 kHz or 13.56 MHz) and using microwave generators (2.45 GHz). Plasma surface treatment may be performed at room temperature or at higher temperatures. The pressure used for plasma surface treatment is typically atmospheric pressure or below atmospheric pressure (e.g. 10-150 Pa).

Further information on how to treat supports such as fabrics with plasma can be found in the paper entitled “Plasma treatment advantages for textiles” by Amelia Sparavigna, of the Physics Department at Politecnico di Torino. A copy is at http://arxiv.org/ftp/arxiv/papers/0801/0801.3727.pdf. Still further information on the plasma treatment of fabrics is provided in the paper entitled “Fundamental investigations on the barrier effect of polyester micro fiber fabrics towards particle-loaded liquids induced by surface hydrophobization” by Nazirul Islam at the Technical University of Dresden (copy at http://hsss.slub-dresden.de/documents/1102323495625-1069/1102323495625-1069.pdf). Due to cost reasons the fabric is preferably free from bonding agents. Further techniques are illustrated in US 2002004994.

Examples of fabrics which may be treated to obtain the desired surface energy (e.g. 1 to 30 mN/m) include polyesters, in particular polyethylene terephthalate, polybutylene terephthalate or copolymers containing polyethylene terephthalate units or polybutylenterephthalate units; polyamides, in particular of aliphatic diamines and dicarbonic acids, of aliphatic aminocarbonic acids or of aliphatic lactams of derived polyamides, or aramids, thus of aromatic diamines and dicarbonic acids of derived polyamides; polyvinyl alcohol; viscose; cellulose; polyolefins, for example polyethylene or polypropylene; polysulfones, for example polyethersulfones and polyphenylenesulfones; polyarylene sulfides, for example polyphenylene sulphide; polycarbonates; polyimides; and mixtures of two or several of these fabrics.

The fabric can be treated, for example with a hydrophobic polymer, e.g. a fluoro polymer or a silicon polymer.

The fluoro compound is preferably a polymeric or non-polymeric fluoro compound.

Examples of polymeric fluoro compounds include polytetrafluoroethylene (ptfe), copolymers of (per)fluoroalkyl acrylate and/or a (per)fluoroalkyl methacrylate. The polymeric fluoro compounds can also serve as binding material for the fibres, for example for non-woven fabrics.

Examples of non-polymeric fluoro compounds include SF₆; CF₄, C₂F₆, C₂F₄, C₃F₆, C₄F₈, trifluoromethane (CHF₃), perfluoro-(2-trifluoromethyl-)pentene, perfluoro-(2-methylpent-2-ene) and its trimer; esters of fluoro alcohols and methacrylic acid or acrylic acid; fluoro oxiranes, e.g. oxiranes, e.g. tetrafluoroethylene oxide (2,2,3,3-tetrafluorooxirane), hexafluoropropylene oxide (2-trifluoromethyl-2-fluoro-3,3-difluorooxirane), 2,2,3,3,4,4-hexafluorooxetane, octafluorobutylene oxide (2,2,3,3,4,4,5,5-octafluorotetrahydropyran) and hexafluoroallyloxide; and mixtures comprising two or more of the foregoing. Preferred non-polymeric fluoro compounds have 8 to 15 carbon atoms (especially to 13 carbons) and at least one C═C double bond, especially heptadecafluorodecylacrylate (HDFDA), heptadecafluorodecene (HDFD) and mixtures thereof:

CF₃(CF₂)₇CH₂CH₂CO₂CH═CH_{2 HDFDA}

CF₃(CF₂)₇CH═CH₂ HDFD

Silicon compounds which may be used to treat the support in order to achieve the desired surface energy include organosilicon compounds, e.g. hexamethyldisiloxane, tetramethyldisiloxane, octa-methyl cyclo tetra siloxane, tetramethylsilane, tetraethoxysilane, vinyltrimethylsilane, fluorotrimethylsilane, hexamethyldisilane, trimethylmethoxysilane; and mixtures comprising two or more of the foregoing.

The surface structure of plasma treated supports is not precisely defined in chemical terms. The surface is however thought to comprise a crosslinked accumulation product of low molecular weight materials activated by the plasma treatment.

When the porous support comprises fibres, typical fibre diameters are 0.01 to 200 micrometers, preferably 0.05 to 50 micrometers. The fibres may be in the form of, for example, pile fibres, filled fibres or mixtures of any of the many diverse fibre types available.

Typically supports derived from non-woven fabrics have a weight of 0.05 to 500 g/m², preferably 1 to 150 g/m², more preferably of 40 to 100 g/m².

As non-woven fabrics are porous, the coating resulting from plasma treatment typically exists within the porous structure as well as at the surface. If desired the plasma treatment may be applied to just one or to both sides of the fabric.

The plasma may be generated by application of an electrostatic field and a conventional porous support (e.g. a non-woven fabric) may be passed through a plasma chamber in order to achieve the desired average surface energy. Typically the conventional porous support is passed through the plasma chamber at a speed of 0.5 to 400 m/min. Chemical compound(s) may be injected into the chamber if desired, for example the compounds mentioned above, which then fix to the porous support. Preferably the plasma contacts with the entire volume of the conventional porous supports being treated.

Suitable plasma treatment techniques are described in WO 2008080454 and the prior art references provided in the description of that publication.

In a preferred embodiment a crosslinker with at least two reactive groups, preferably ethylenically unsaturated groups, are included in the plasma treatment.

The conventional porous support may be subjected to more than one plasma treatment if desired.

In an other embodiment the conventional porous support is pre-treated before the plasma treatment, for example with polytetrafluoroethylene.

The Examples of WO 2008080454 describes a number of surface treated non-woven fabrics.

The process of the present invention is preferably performed such that the composition partly penetrates into the porous support. This preference arises because it leads to good adhesion between the porous support and the composition, particularly when the composition has been cured. Mechanical interlocking of the composition as its viscosity increases (e.g. by curing) helps to prevent or reduce the incidence of delamination. Preferably at least 2% by volume, more preferably at least 10% by volume of the composition penetrates the porous support.

In one embodiment 40 to 60% by volume of the composition penetrates the porous support. In other embodiments >60%, up to 90%, or even 100% by volume of the compositions penetrates into the support, provided of course that the composition does not penetrate through to the opposite side of the support.

The higher degrees of penetration mentioned above are particularly advantageous when the composition after its viscosity increase (e.g. a polymer resulting from curing the composition) has low mechanical strength. In this case the support acts to strengthen what would otherwise be a weak coating formed from the composition and a more durable composite membrane may result.

The degree of penetration of the composition into the porous support can be controlled in various ways, for example by appropriate selection of the surface energy and density of the support, the surface tension of the composition and the time interval between application of the composition onto the support and the viscosity increasing step. To facilitate partial penetration, the surface tension of the composition is preferably at least 25, more preferably 25 to 45 mN/m, especially 25 to 35 mN/m, more especially 25 to 30 mN/m higher than the surface energy of the support. In a preferred embodiment the surface tension of the composition is preferably at least 25 mN/m higher, more preferably 25 to 45 mN/m, more preferably 25 to 40 mN/m, especially 25 to 35 mN/m higher than the surface energy of the support.

The dry thickness of the composite membrane (i.e. including the support) is preferably <500 μm, more preferably 10 to 350 μm, especially 20 to 200 μm.

When intended to be used as an anion or cation exchange membrane, the composite membrane preferably has an ion exchange capacity of at least 0.3 meq/g, more preferably of at least 0.5 meq/g, especially >1.0 meq/g, based on the total dry weight of the membrane. Ion exchange capacity may be measured by titration as described below in the examples section.

Preferably the composite membrane—when intended for use as an ion exchange membrane—has a charge density of at least 20 meq/m², more preferably at least 30 meq/m², especially at least 40 meq/m², based on the area of a dry membrane. Charge density may be measured as described above for ion exchange capacity.

Preferably the composite membrane—when intended for use as an ion exchange membrane—has a permselectivity for anions (e.g. for Cl⁻ ions) of >75%, more preferably >80%, especially >85%, more especially >90%. Preferably the membrane has a permselectivity for cations (e.g. Na⁺ ions) of >75%, more preferably >80%, especially >85%, more especially >90%.

Preferably the composite membrane—when intended for use as an ion exchange membrane—has an electrical resistance <10 ohm/cm², more preferably <5 ohm/cm², most preferably <3 ohm/cm². Preferably the membrane exhibits a swelling in water of <50%, more preferably <20%, most preferably <10%. The degree of swelling can be controlled by selecting appropriate parameters, e.g. in the curing step (if any).

The water uptake of the membrane when soaked in water is preferably <50% based on weight of dry membrane, more preferably <40%, especially <30%.

Electrical resistance, permselectivity and % swelling in water may be measured by the methods described by Djugolecki et al, J. of Membrane Science, 319 (2008) on pages 217-218.

Typically the ion exchange membrane is substantially non-porous e.g. the pores are smaller than the detection limit of a standard Scanning Electron Microscope (SEM). Thus using a Jeol JSM-6335F Field Emission SEM (applying an accelerating voltage of 2 kV, working distance 4 mm, aperture 4, sample coated with Pt with a thickness of 1.5 nm, magnification 100,000×, 3° tilted view) the average pore size is generally <5 nm.

Step (ii) preferably causes the composition to form a layer (e.g. a polymeric layer) having lower porosity than the porous support. This layer may act as a discriminating layer in the resultant composite membrane whereas the porous support primarily provides mechanical strength to this discriminating layer.

The composition preferably has a surface tension of 16 to 45 mN/m, more preferably 16 to 40 mN/m, especially 20 to 40 mN/m, more especially 25 to 35 mN/m, preferably as measured at 25° C.

The viscosities preferably are as measured at 25° C. and a shear rate of 40 s⁻¹.

The composition is preferably a curable composition.

In preferred embodiments the membrane is an ion exchange membrane.

Preferably the acidic or basic groups which may be present in the membrane are derived from a copolymerisable substance included in the composition. For example, weakly acidic or weakly basic groups which may be present in the membrane may conveniently be obtained by including in the composition a crosslinking agent having one or more groups selected from weakly acidic groups, weakly basic groups and groups which are convertible to weakly acidic or weakly basic groups. Alternatively the weakly acidic or weakly basic groups in the membrane may be obtained by including in the composition a curable compound having one acrylic group and one or more groups selected from weakly acidic groups, weakly basic groups and groups which are convertible to weakly acidic or weakly basic groups.

However the membrane may also comprise strongly acidic or basic groups such as sulpho groups or quaternary ammonium groups.

In one embodiment the composition comprises a crosslinking agent having two acrylic groups and one or more groups selected from weakly acidic groups, weakly basic groups and groups which are convertible to weakly acidic or weakly basic groups and the composition is free from curable compounds having one acrylic group.

The presence in the composition of a curable compound having one (i.e. only one) acrylic group can impart a useful degree of flexibility to the membrane. Preferably the curable compound having one acrylic group has one or more groups selected from weakly acidic groups, weakly basic groups and groups which are convertible to weakly acidic or weakly basic groups.

In another embodiment the membrane is obtained from curing a composition comprising (a) a curable compound having one acrylic group and one or more groups selected from acidic groups and basic groups; and (b) a crosslinking agent having two acrylic groups and being free from acidic groups and basic groups.

In a preferred embodiment the composition comprises (a) a curable compound having one acrylic group and one or more groups selected from weakly acidic groups, weakly basic groups and groups which are convertible to weakly acidic or weakly basic groups; and (b) a crosslinking agent having two acrylic groups and being free from weakly acidic groups, weakly basic groups and groups which are convertible to weakly acidic or weakly basic groups.

The composition may of course contain further components in addition to those specifically mentioned above. For example the composition optionally comprises one or more further crosslinking agents and/or one or more further curable compounds, which in each case is free from weakly acidic groups, weakly basic groups and groups which are convertible to weakly acidic or weakly basic groups. The presence of such further agents and/or compounds can be useful for reducing the total number of weakly acidic or weakly basic groups on the membrane to a particular target amount.

When the crosslinking agent or the curable compound has groups which are convertible to weakly acidic or weakly basic groups the process preferably comprises the further step of converting such groups into weakly acidic or weakly basic groups, e.g. by a condensation or etherification reaction. Preferred condensation reactions are nucleophilic substitution reactions, for example the membrane may have a labile atom or group (e.g. a halide) which is reacted with a nucleophilic compound having a weakly acidic or basic group to eliminate a small molecule (e.g. hydrogen halide) and produce a membrane having the desired weakly acidic or basic group. An example of a hydrolysis reaction is where the membrane carries side chains having ester groups which are hydrolysed to acidic groups. Preferably the crosslinking agent has three or, more preferably, two acrylic groups. In a particularly preferred embodiment the crosslinking agent has two acrylic groups and the curable compound has one acrylic group.

Acrylic groups are of the formula H₂C═CH—C(═O)—. Preferred acrylic groups are acrylate (H₂C═CH—C(═O)—O—) and acrylamide (H₂C═CH—C(═O)—N<) groups.

It has also been found that the use of weakly acidic and weakly basic curable compounds yields membranes which are useful for electro-deionization and electrodialysis. Furthermore, such membranes may be prepared under mild process conditions (e.g. at ambient temperatures and without using extremes of pH).

Preferably the composition is substantially free from water and organic solvents (e.g. the composition contains <5 wt %, more preferably <2 wt % in total of water and organic solvents) because this avoids the time and expense of drying the resultant membrane. The word ‘substantially’ is used because it is not possible to rule out the possibility of there being trace amounts of water and/or organic solvents in the components used to make the composition (because they are unlikely to be perfectly dry). Low amounts of water and/or organic solvents are acceptable since they usually will evaporate before and/or during the viscosity increasing step.

The use of weakly acidic and weakly basic curable compounds has the advantage of avoiding the need to include water in the composition and in turn this avoids or reduces the need for energy intensive drying steps in the process.

When the composition is substantially free from water and organic solvents the components of the composition will typically be selected so that they are all liquid at the temperature at which they are applied to the support or such that any components which are not liquid at that temperature are soluble in the remainder of the composition.

To achieve a membrane with a limited swelling degree (water uptake <50%) the crosslinking density should not be too low. This may be achieved by using multifunctional crosslinking agents or by using difunctional crosslinking agents of which the functional groups are not very far apart, e.g. by using a compound of limited molecular weight. In one embodiment the crosslinking agents present in the composition all have a molecular weight of at most 350 per acrylic group.

Preferably the composition is substantially free from methacrylic compounds (e.g. methacrylate and methacrylamide compounds), i.e. the composition comprises at most 10 wt % of compounds which are free from acrylic groups and comprise one or more methacrylic groups.

The composition may comprise one or more than one crosslinking agent comprising at least two acrylic groups. When the curable composition comprises more than one crosslinking agent comprising at least two acrylic groups none, one or more than one of such crosslinking agents may have one or more groups selected from weakly acidic groups weakly basic groups and groups which are convertible to weakly acidic or weakly basic groups.

The composition may comprise none, one or more than one curable compound having one acrylic group. The composition preferably comprises:
(a) 10 to 99 parts in total of crosslinking agent(s) comprising two acrylic groups;
(b) 10 to 99 parts in total curable compounds having one acrylic group, at least ten of the parts having one or more groups selected from weakly acidic groups, weakly basic groups and groups which are convertible to weakly acidic or weakly basic groups;
(c) 0 to 50 parts in total of crosslinking agent(s) comprising more than two acrylic groups; and
(d) 0 to 10 parts in total of methacrylic compounds; and
(e) 0.01 to 5 parts in total of photoinitiator(s);
   wherein all parts are by weight.

Component (a) is preferably present in the composition in an amount of 30 to 90 parts, more preferably 35 to 85 parts, more especially 40 to 60 parts, wherein all parts are by weight.

Component (b) is unable to crosslink because it has only one acrylic group (e.g. one H₂C═CHCO₂— or H₂C═CHCON<group). However it is able to react with other components present in the composition. Component (b) can provide the resultant membrane with a desirable degree of flexibility. It also assists the membrane in distinguishing between ions of different charges by the presence of weakly acidic or basic groups.

Generally component (a) provides strength to the membrane, while potentially reducing flexibility.

Compositions containing crosslinking agent(s) comprising two or more acrylic groups can sometimes be rather rigid and in some cases this can adversely affect the mechanical properties of the resultant membrane. However too much curable compound having only one acrylic group can lead to a membrane with a very loose structure. Also the efficiency of the curing can reduce when large amounts of curable compound having only one acrylic group are used, increasing the time taken to complete curing and potentially requiring inconvenient conditions therefore. Bearing these factors in mind, the number of parts of component (b) is preferably 10 to 90, more preferably 30 to 70, especially 40 to 60 parts by weight.

The presence of component (c) can also provide strength to the membrane. The presence of 3 or more crosslinkable groups also helps the formation of a three dimensional polymer network in the resultant membrane. However too much of component (c) may lead to a rigid structure and inflexibility of the membrane may result. Bearing these factors in mind, the number of parts of component (c) is preferably 0 to 30, more preferably 0 to 10, by weight.

While component (d) may be present in small amounts, methacrylic compounds often slow the curing rate and therefore make the process less efficient. Therefore the composition preferably comprises 0 to 10 parts, more preferably 0 to 5 parts, especially 0 to 2 parts and more especially 0 parts in total of methacrylic compounds.

The composition may contain other components, for example surfactants, viscosity controlling agents, plasticizers, binders, biocides or other ingredients.

Preferably the coating formed from the composition when step (ii) is completed has a thickness of 1 to 500 μm. The thickness may be determined by Scanning Electron Microscopy.

While this does not rule out the presence of other components in the composition (because it merely fixes the relative ratios of components (a), (b), (c), (d) and (e)), preferably the number of parts of (a), (b), (c), (d) and (e) add up to 100.

Taking the above factors into account, the composition preferably comprises:
(a) 40 to 60 parts in total of crosslinking agent(s) comprising two acrylic groups;
(b) 40 to 60 parts in total curable compounds having one acrylic group, at least ten of the parts having one or more groups selected from weakly acidic groups, weakly basic groups and groups which are convertible to weakly acidic or weakly basic groups;
(c) 0 to 10 parts in total of crosslinking agent(s) comprising more than two acrylic groups;
(d) 0 to 5 parts in total of methacrylic compounds; and
(e) 0.01 to 5 parts in total of photoinitiator(s);
   wherein all parts are by weight.

Preferably the number of parts of (a), (b), (c), (d) and (e) add up to 100. This does not rule out the presence of further, different components but merely sets the ratio of the mentioned components relative to each other.

Crosslinking agents and curable compounds having acrylic groups are preferred because of their fast polymerisation rates, especially when using UV light to effect the polymerisation. Especially preferred crosslinking agents and curable compounds having acrylic groups are the epoxy acrylate compounds which are generally even more reactive then non-epoxy acrylate groups. Many crosslinking agents and curable compounds having acrylic groups are also easily available from commercial sources.

The network structure of the membrane when derived from curable components is determined to a large extent by the identity of crosslinkable compounds and their functionality, e.g. the number of crosslinkable groups they contain per molecule.

Examples of suitable curable compounds having one acrylic group include dimethylaminopropyl acrylamide, 2-hydroxyethyl acrylate, polyethylene glycol monoacrylate, hydroxypropyl acrylate, polypropylene glycol monoacrylate, 2-methoxyethyl acrylate, 2-phenoxyethyl acrylate, acrylic acid, maleic acid, maleic acid anhydride and combinations thereof. Dimethylaminopropyl acrylamide comprises a weakly basic group, acrylic acid, maleic acid and maleic acid anhydride comprise a weakly acid group (in the latter case this is masked as an anhydride).

Examples of suitable crosslinking agent(s) comprising two acrylic groups include poly(ethylene glycol) diacrylate, bisphenol-A epoxy acrylate, bisphenol A ethoxylate diacrylate, tricyclodecane dimethanol diacrylate, neopentyl glycol ethoxylate diacrylate, propanediol ethoxylate diacrylate, butanediol ethoxylate diacrylate, hexanediol diacrylate, hexanediol ethoxylate diacrylate, poly(ethylene glycol-co-propylene glycol) diacrylate, poly(ethylene glycol)-block-poly(propylene glycol)-block-poly(ethylene glycol) diacrylate, a diacrylate of a copolymer of polyethylene glycol and other building blocks e.g. polyamide, polycarbonate, polyester, polyimide, polysulfone, and combinations thereof.

Preferably the composition is substantially free from divinyl benzene.

Preferably the composition is substantially free from styrene.

Examples of suitable crosslinking agent(s) comprising more than two acrylic groups include glycerol ethoxylate triacrylate, trimethylolpropane ethoxylate triacrylate, trimethylolpropane ethoxylate triacrylate, pentaerythrytol ethoxylate tetraacrylate, ditrimethylolpropane ethoxylate tetraacrylate, dipentaerythrytol ethoxylate hexaacrylate and combinations thereof.

For acrylates, diacrylates, and higher-acrylates, type I photo-initiators are preferred. Examples of I photo-initiators are as described in WO 2007/018425, page 14, line 23 to page 15, line 26, which are incorporated herein by reference thereto. Especially preferred photoinitiators include alpha-hydroxyalkylphenones, such as 2-hydroxy-2-methyl-1-phenyl propan-1-one, 2-hydroxy-2-methyl-1-(4-tert-butyl-) phenylpropan-1-one, 2-hydroxy-[4″-(2-hydroxypropoxy)phenyl]-2-methylpropan-1-one, 2-hydroxy-1-[4-(2-hydroxyethoxy)phenyl]-2-methyl propan-1-one, 1-hydroxycyclohexylphenyl ketone and oligo[2-hydroxy-2-methyl-1-{4-(1-methylvinyl)phenyl}propanone], alpha-aminoalkylphenones, alpha-sulfonylalkylphenones and acylphosphine oxides such as 2,4,6-trimethylbenzoyl-diphenylphosphine oxide, ethyl-2,4,6-trimethylbenzoylphenylphosphinate and bis(2,4,6-trimethylbenzoyl)-phenylphosphine oxide.

Preferably the ratio of photo-initiator to the remainder of the curable composition is between 0.0001 and 0.2 to 1, more preferably between 0.001 and 0.1 to 1, based on weight.

Steps (i) and (ii) are preferably each independently performed at a temperature between 10 and 60° C. While higher temperatures may be used, these are not preferred because of the expense.

A variety of techniques may be used to achieve the rapid viscosity increase required by step (ii). For example, the viscosity increase may also be achieved by rapid evaporation of a volatile component of the composition to leave behind viscous and/or solid components, e.g. by infrared or electromagnetic (e.g. micro-wave) irradiation. Drying by infrared can be suitably done by carbon infrared (CIR) heaters.

The viscosity increase in step (ii) is preferably achieved by curing, especially curing by radical polymerisation, preferably using electromagnetic radiation. The source of radiation may be any source which provides the wavelength and intensity of radiation necessary to cure the composition. A typical example of a UV light source for curing is an H-bulb with an output of 600 Watts/inch (240 W/cm) as supplied by Fusion UV Systems which has emission maxima around 220 nm, 255 nm, 300 nm, 310 nm, 365 nm, 405 nm, 435 nm, 550 nm and 580 nm. Alternatives are the V-bulb and the D-bulb which have a different emission spectrum with main emissions between 350 and 450 nm and above 400 nm respectively.

During curing (when performed) the crosslinking agent(s) polymerise to form a polymer. The curing may be brought about by any suitable means, e.g. by irradiation and/or heating, provided curing occurs sufficiently rapidly to form a membrane within the 30 seconds. If desired further curing may be applied subsequently to finish off, although generally this is not necessary.

The viscosity increase is preferably achieved thermally (e.g. by irradiating with infrared light) or by irradiating the composition with ultraviolet light or an electron beam.

For thermal curing the curable composition preferably comprises one or more thermally reactive free radical initiators, preferably being present in an amount of 0.01 to 5 parts per 100 parts of curable and crosslinkable components in the curable composition, wherein all parts are by weight.

Examples of thermally reactive free radical initiators include organic peroxides, e.g. ethyl peroxide and/or benzyl peroxide; hydroperoxides, e.g. methyl hydroperoxide, acyloins, e.g. benzoin; certain azo compounds, e.g. α,α′-azobisisobutyronitrile and/or γ,γ′-azobis(γ-cyanovaleric acid); persulfates; peracetates, e.g. methyl peracetate and/or tert-butyl peracetate; peroxalates, e.g. dimethyl peroxalate and/or di(tert-butyl) peroxalate; disulfides, e.g. dimethyl thiuram disulfide and ketone peroxides, e.g. methyl ethyl ketone peroxide. Temperatures in the range of from about 30° C. to about 150° C. are generally employed for infrared curing. More often, temperatures in the range of from about 40° C. to about 110° C. are used.

Preferably the viscosity increase referred to in step (ii) occurs within 25 seconds, more preferably within 15 seconds, e.g. within 14 seconds, especially within 10 seconds and most preferably within 6 seconds, e.g. in about 3 seconds, of the composition being applied to the support layer. The time chosen will depend on a number of factors, for example the average surface energy of the support and the surface tension of the composition, the time being selected so as to prevent the composition from completely soaking through the support and polluting surfaces (e.g. rollers) thereunder. Partial penetration of the composition into the porous support may be allowed to enhance the mechanical bonding of the resultant membrane to the porous support. The penetration depths can be controlled by e.g. selecting appropriate combinations of average surface energy of the support, surface tension of the composition (by the solvent, if present, or the surfactant, if present), the thickness of the applied layer and the time interval between the application on the support and the viscosity increase.

Preferably the viscosity increase referred to in step (ii) is achieved by irradiating the composition for <10 seconds, more preferably <5 seconds, especially <3 seconds, more especially <2 seconds. In a continuous process the irradiation may be performed continuously and the speed at which the curable composition moves through the beam of the irradiation is mainly what determines the time period of curing.

When high intensity UV light is used for curing a considerable amount of heat may be generated. To prevent over-heating one may therefore apply cooling air or water to the lamps and/or the support/membrane. Often a significant dose of IR light is irradiated together with the UV-beam. In one embodiment curing is performed by irradiation using UV light filtered through an IR reflecting quartz plate. Alternatively a selective mirror may be used.

Preferably the curing uses ultraviolet light. Suitable wavelengths are for instance UV-A (400 to >320 nm), UV-B (320 to >280 nm), UV-C (280 to 200 nm), provided the wavelength matches with the absorbing wavelength of any photo-initiator included in the composition.

Suitable sources of ultraviolet light are mercury arc lamps, carbon arc lamps, low pressure mercury lamps, medium pressure mercury lamps, high pressure mercury lamps, swirlflow plasma arc lamps, metal halide lamps, xenon lamps, tungsten lamps, halogen lamps, lasers and ultraviolet light emitting diodes. Particularly preferred are ultraviolet light emitting lamps of the medium or high pressure mercury vapour type. In addition, additives such as metal halides may be present to modify the emission spectrum of the lamp. In most cases lamps with emission maxima between 200 and 450 nm are particularly suitable.

The energy output of the irradiation source is preferably from 20 to 1000 W/cm, preferably from 40 to 500 W/cm but may be higher or lower as long as the desired exposure dose can be realized. The exposure intensity is one of the parameters that can be used to control the extent of curing which influences the final structure of the membrane. Preferably the exposure dose is at least 40 mJ/cm², more preferably between 40 and 600 mJ/cm², most preferably between 70 and 220 mJ/cm² as measured by an High Energy UV Radiometer (UV Power Puck™ from EIT—Instrument Markets) in the UV-B range indicated by the apparatus. More preferably the exposure dose is at least 40 mJ/cm², especially 40 to 1500 mJ/cm², more especially 70 to 900 mJ/cm². The dose may be measured using a High Energy UV Radiometer (UV PowerMap™ from EIT, Inc) in the UV-A and UV-B range indicated by the apparatus. Exposure times can be chosen freely but preferably are short and are typically <2 seconds.

To reach the desired dose at high coating speeds more than one UV lamp may be required, so that the composition is exposed to more than one lamp. When two or more lamps are applied all lamps may give an equal dose or each lamp may have an individual setting. For instance the first lamp may give a higher dose than the second and following lamps or the exposure intensity of the first lamp may be lower. Also by using two or more types of lamps one may irradiate the composition with two or more different wavelengths of light. This can be advantageous to achieve a good combination of curing properties, for example when one lamp emits light of a wavelength which achieves a good surface cure and another lamp emits light of a wavelength which achieves a good cure depth. In a preferred embodiment the composition is cured by simultaneous irradiation from opposite sides using two or more irradiation sources, e.g. two lamps (one on each side). The two or more irradiation sources preferably irradiate the composition with the same intensity. This symmetric configuration has the advantage that a higher crosslinking efficiency can be achieved and curling of the membrane can be reduced or prevented.

Photo-initiators may be included in the composition and are usually required when curing uses UV or visible light radiation. Suitable photo-initiators are those known in the art such as radical type, cation type or anion type photo-initiators.

In one embodiment the viscosity of the composition is increased to a value higher than 100,000 mPa·s within 30 seconds after the composition has been applied to the support.

In another embodiment the viscosity of the composition is preferably increased to a value higher than 30,000 mPa·s within 14 seconds after the composition has been applied to the support.

When no photo-initiator is included in the curable composition, the composition can be cured by electron-beam exposure, e.g. using an exposure of 50 to 300 keV. Curing can also be achieved by plasma or corona exposure.

Curing rates may be increased by including an amine synergist in the composition. Suitable amine synergists are e.g. free alkyl amines such as triethylamine, methyldiethanol amine, triethanol amine; aromatic amine such as 2-ethylhexyl-4-dimethylaminobenzoate, ethyl-4-dimethylaminobenzoate and also polymeric amines as polyallylamine and its derivatives. Curable amine synergists such as ethylenically unsaturated amines (e.g. acrylated amines) are preferable since their use will give less odour due to their ability to be incorporated into the membrane by curing and also because they may contain a weakly basic group which can be useful in the final membrane. The amount of amine synergists is preferably from 0.1-10 wt. % based on the weight of polymerizable compounds in the composition, more preferably from 0.3-3 wt. %.

Where desired, a surfactant or combination of surfactants may be included in the composition as a wetting agent or to adjust surface tension. Commercially available surfactants may be utilized, including radiation-curable surfactants. Surfactants suitable for use in the composition include non-ionic surfactants, ionic surfactants, amphoteric surfactants and combinations thereof.

Preferred surfactants are as described in WO 2007/018425, page 20, line 15 to page 22, line 6, which are incorporated herein by reference thereto. Fluorosurfactants are particularly preferred, especially Zonyl® FSN (produced by E.I. Du Pont).

The permeability to ions can be influenced by the swellability of the membrane and by plasticization. By plasticization compounds penetrate the membrane and act as plasticizer. The degree of swelling can be controlled by the types and ratio of crosslinkable compounds, the extent of crosslinking (exposure dose, photo-initiator type and amount) and by other ingredients.

In one embodiment at least two compositions are coated (simultaneously or consecutively) onto the support. Thus coating may be performed more than once, either with or without curing being performed between each coating step. As a consequence a composite membrane may be formed comprising at least one top layer and at least one bottom layer that is closer to the support than the top layer.

When a radical initiator is present in the composition, preferably a polymerisation inhibitor is also included (e.g. in an amount of below 2 wt %). This is useful to prevent premature curing of the composition during, for example, storage. Suitable polymerisation inhibitors include hydroquinone, hydroquinone mono methyl ether, 2,6-di-t-butyl-4-methylphenol, 4-t-butyl-catechol, phenothiazine, 4-oxo-2,2,6,6-tetramethyl-1-piperidinoloxy, free radical, 4-hydroxy-2,2,6,6-tetramethyl-1-piperidinoloxy, free radical, 2,6-dinitro-sec-butylphenol, tris(N-nitroso-N-phenylhydroxylamine) aluminum salt, Omnistab™ IN 510 and mixtures comprising two or more thereof.

Other additives which may be included in the composition are acids, pH controllers, preservatives, viscosity modifiers, stabilisers, dispersing agents, antifoam agents, organic/inorganic salts, anionic, cationic, non-ionic and/or amphoteric surfactants and the like in accordance with the objects to be achieved.

The process of the present invention may contain further steps if desired, for example washing and/or drying the membrane. When the composition comprises curable compounds having groups which are convertible to (weakly) acidic or (weakly) basic groups the process may further comprise the step of converting the groups which are convertible to (weakly) acidic or (weakly) basic groups into weakly acidic or weakly basic groups.

Preferred weakly acidic groups are carboxy groups and phosphato groups. These groups may be in the free acid or salt form, preferably in the free acid form. Examples of acrylate compounds having weakly acidic groups include acrylic acid, beta carboxy ethyl acrylate, maleic acid and maleic acid anhydride. Examples of acrylamide compounds having weakly acidic groups include phosphonomethylated acrylamide, carboxy-n-propylacrylamide and (2-carboxyethyl)acrylamide.

Preferred weakly basic groups are secondary amine and tertiary amine groups. Such secondary and tertiary amine groups can be in any form, for example they may be cyclic or acyclic. Cyclic secondary and tertiary amine groups are found in, for example, imidazoles, indazoles, indoles, triazoles, tetrazoles, pyrroles, pyrazines, pyrazoles, pyrrolidinones, triazines, pyridines, pyridinones, piperidines, piperazines, quinolines, oxazoles and oxadiazoles. Examples of acrylate compounds having weakly basic groups include N,N-dialkyl amino alkyl acrylates, e.g. dimethylaminoethyl acrylate, dimethylaminopropyl acrylate and butylaminoethyl acrylate. Examples of acrylamide compounds having weakly basic groups include N,N-dialkyl amino alkyl acrylamides, e.g. dimethylaminopropyl acrylamide.

The groups which are convertible to weakly acidic groups include hydrolysable ester groups.

The groups which are convertible to weakly basic groups include haloalkyl groups (e.g. chloromethyl, bromomethyl, 3-bromopropyl etc.). Haloalkyl groups may be reacted with amines to give weakly basic groups. Examples of compounds having groups which are convertible into weakly basic groups include methyl 2-(bromomethyl)acrylate, ethyl 2-(bromomethyl)acrylate, tert-butyl α-(bromomethyl)acrylate, isobornyl α-(bromomethyl)acrylate, 2-bromo ethyl acrylate, 2-chloroethyl acrylate, 3-bromopropyl acrylate, 3-chloropropyl acrylate, 2-hydroxy-3-chloropropyl acrylate and 2-chlorocyclohexyl acrylate.

Preferably however the composition comprises one or more curable compounds having one or more acrylic groups and one or more substituents selected from weakly acidic groups and weakly basic groups.

Surprisingly ion exchange membranes with weakly basic or acidic groups (e.g. tertiary amino, carboxyl and phosphato groups) can exhibit good properties in terms of their permselectivity and conductivity while at the same time being not overly expensive to manufacture by the present process.

Hitherto membranes have generally been made in slow and energy intensive processes, often having many stages. The present invention enables the manufacture of membranes in a simple process that may be run continuously for long periods of time to mass produce membranes relatively cheaply. The process can also be used to make membranes without the composition permeating through the support and fouling surfaces underneath, for example rollers which may be used in an automated process.

The process of the invention may be used to produce homogeneous membranes as well as heterogeneous membranes.

The membranes of the invention are primarily intended for use as charge barriers in water purification applications, e.g. electro-deionisation, continuous electro-deionisation, and in flow through capacitors. However they may also be used in other areas, for example reverse electrodialysis, especially for the generation of energy, fuel cells, filtration techniques (e.g. reverse osmosis, nano- and microfiltration), gas separation, functional textiles, e.g. technical or protective clothing, dehumidification and the like.

The membranes may be used as electrodialysis (ED) membranes. ED membranes are used in conjunction with an applied electric potential difference to separate ions. The ion separation may be done in a configuration called an electrodialysis cell. The cell typically comprises a feed compartment and a concentrate compartment. In almost all practical electrodialysis processes, multiple electrodialysis cells are arranged into a configuration called an electrodialysis stack, with alternating anion and cation exchange membranes forming the multiple electrodialysis cells.

Electrodialysis processes are distinct from distillation techniques and other membrane-based processes (such as reverse osmosis) in that dissolved species are moved away from the feed stream rather than the reverse.

The support may have the function of transporting the curable composition in the form of a thin film to a curing source.

Preferably the composition is free from compounds having tetralkyl-substituted quaternary ammonium groups.

Preferably the composition is free from compounds having sulpho groups.

Bearing in mind the above, a preferred process according to the invention prepares a composite anion or cation exchange membrane and comprises the steps of:
(i) applying to a porous support having an average surface energy of 1 to 30 mN/m a curable composition having a viscosity of below 150 mPa·s; and
(ii) increasing the viscosity of the composition to a value higher than 30,000 mPa·s within 30 seconds by irradiating the composition for <10 seconds, thereby forming a membrane having an ion exchange capacity of at least 0.3 meq/g based on the dry weight of the membrane;
   wherein the composition applied in step (i) has a surface tension that is at least 25 mN/m higher than the average surface energy of the porous support.

The amount of composition applied to the porous support preferably lies within the range of 1 to 300 g/m², more preferably 10 to 200 g/m² and especially 50 to 150 g/m².

The wet thickness of composition applied to the porous support preferably lies within the range of 1 to 300 μm, more preferably 10 to 200 μm and especially 50 to 150 μm.

According to a second aspect of the present invention there is provided a composite membrane obtained by the process of the present invention.

Preferably the composite membrane comprises a porous support having an average surface energy of 1 to 30 mN/m, as measured prior to coating, and a polymeric layer in contact therewith comprising cured ethylenically unsaturated compounds. More preferably the porous support has an average surface energy of 1 to 25 mN/m, especially 1 to 20, more especially 1 to 15 mN/m, even more especially 2 to 10 mN/m, as measured prior to coating. The polymeric layer is derived from the composition.

Preferably the resultant composite membrane has an average surface energy on at least one side of at least 30 mN/m, more preferably 30 to 80 mN/m, especially 35 to 70 mN/m, e.g. about 50 mN/m.

The polymeric layer is preferably free from polymerized fluorine compounds.

Preferably at least a part of the polymeric layer is present in the pores of the porous support. This preference arises because the presence of at least a part of the polymeric layer in the pores of the support achieves good adhesion between the support and the polymeric layer. Preferably at least 2% by volume, more preferably at least 10% by volume of the polymeric layer is present in the pores of the porous support. The % by volume of the polymeric layer present in the pores of the porous support can be determined from scanning electron microscope images: for example 90% of the polymeric layer may be on top of the support and 10% may have penetrated into the pores of the support.

When intended for use as a gas separation membrane or an ion exchange membrane, the composite membrane is preferably substantially non-porous, i.e. having a low water permeability. Preferably the membrane's water permeability at 20° C. is lower than 1×10⁻⁷ m³/m².s.kPa, more preferably lower than 3×10⁻⁸ m³/m².s.kPa, most preferably lower than 5×10⁻⁹ m³/m².s.kPa, especially lower than 1×10⁻⁹ m³/m².s.kPa. The requirements for water permeability depend on the intended use of the membrane.

The preferences for the support and the composition are as described above in relation to the process.

The membranes according to a second aspect of the present invention are preferably obtained by a process according to the first aspect of the present invention.

The membranes of the invention may be used for a number of applications, including electro-deionisation, continuous electro-deionisation, electrodialysis, electrodialysis reversal and capacitive deionisation used in e.g. flow through capacitors, for the purification of water e.g. by removal of dissolved ions, and for other applications including waste water treatment, Donnan or diffusion dialysis for e.g. fluoride removal or the recovery of acids, pervaporation e.g. for dehydration of organic solvents, fuel cells, electrolysis e.g. of water or for chlor-alkali production, for the generation of electricity e.g. by reverse electrodialysis where electricity is generated from two streams differing in salt concentration separated by an ion-permeable membrane, and for the separation of gasses and vapours.

According to a third aspect of the present invention there is provided an electro-deionisation unit comprising an ion-concentrating compartment, an ion-depleting compartment, an anode, a cathode and ionically charged membranes separating the said compartments, CHARACTERISED IN THAT at least one of the membranes is as defined in the second aspect of the present invention.

The electro-deionisation unit preferably comprises a plate-and-frame module or a spiral wound module. Preferably the one or more ion exchange membranes of the unit comprise a membrane according to the second aspect of the present invention having weakly acidic groups and a membrane according to the second aspect of the present invention having weakly basic groups. The electro-deionisation unit is preferably a continuous electro-deionisation unit.

According to a fourth aspect of the invention there is provided a flow through capacitor comprising one or more ionically charged membranes, CHARACTERISED IN THAT at least one of the membranes is as defined in the second aspect of the present invention.

According to a fifth aspect of the present invention there is provided an electrodialysis or reverse electrodialysis unit comprising one or more membranes according to the second aspect of the present invention.

Preferably the electrodialysis or reverse electrodialysis unit comprises at least one anode, at least one cathode and one or more membranes according to the second aspect of the present invention. Further the unit preferably comprises an inlet for providing a flow of relatively salty water along a first side of a membrane according to the present invention and an inlet for providing a less salty flow water along a second side of the membrane such that ions pass from the first side to the second side of the membrane. Preferably the one or more membranes of the unit comprise a membrane having cationic groups and a further membrane having anionic groups.

In a preferred embodiment the unit comprises at least 3, more preferably at least 5, e.g. 36, 64 or up to 500, membranes according to the second aspect of the present invention (the number of membranes being dependent on the intended use of the membrane). The membrane may for instance be used in a plate-and-frame or stacked-disk configuration or in a spiral-wound design. Alternatively, a continuous first membrane according to the present invention having cationic groups may be folded in a concertina (or zigzag) manner and a second membrane having anionic groups (i.e. of opposite charge to the first membrane) may be inserted between the folds to form a plurality of channels along which fluid may pass and having alternate anionic and cationic membranes as side walls.

According to a sixth aspect of the present invention there is provided a diffusion dialysis apparatus comprising one or more membranes according to the second aspect of the present invention.

According to a seventh aspect of the present invention there is provided a membrane electrode assembly comprising one or more membranes according to the second aspect of the present invention. A membrane electrode assembly additionally comprises an anode catalyst layer, a cathode catalyst layer and may comprise gas diffusion backing layers.

The invention will now be illustrated with non-limiting examples where all parts and percentages are by weight unless specified otherwise.

### EXAMPLES

In the examples the following properties were measured by the methods described below.

### Permselectivity

Permselectivity was measured by using a static membrane potential measurement. Two cells are separated by the membrane under investigation. Prior to the measurement the membrane was equilibrated in a 0.5 M NaCl solution for at least 16 hours. Two streams having different NaCl concentrations were passed through cells on opposite sides of the membranes under investigation. One stream had a concentration of 0.1M NaCl (from Sigma Aldrich, min. 99.5% purity) and the other stream was 0.5 M NaCl. The flow rate was 0.74 litres/min. Two double junction Ag/AgCl reference electrodes (from Metrohm AG, Switzerland) were connected to capillary tubes that were inserted in each cell and were used to measure the potential difference over the membrane. The effective membrane area was 3.14 cm² and the temperature was 25° C.

When a steady state was reached, the membrane potential was measured (ΔVₘₑₐₛ)

The permselectivity (α(%)) of the membrane was calculated according the formula:

α(%)=ΔVₘₑₐₛ/ΔVₜₕₑₒᵣ*100%.

The theoretical membrane potential (ΔVₜₕₑₒᵣ) is the potential for a 100% permselective membrane as calculated using the Nernst equation.

### Electrical Resistance

Electrical resistance was measured by the method described by Djugolecki et al, J. of Membrane Science, 319 (2008) on page 217-218 with the following modifications:

the auxiliary membranes were from Tokuyama Soda, Japan;

the effective area of the membrane was 3.14 cm²;

the pumps used were Masterflex easyload II from Cole-Palmer;

the capillaries were filled with 3M KCl;

the reference electrodes were from Metrohm; and

cells 1, 2, 5 and 6 contained 0.5 M Na₂SO₄.

### Surface Tension, Viscosity and Surface Energy and Surface Tension

The surface tension of single-component probe liquids was taken from literature. For the curable compositions, the surface tension was measured at 25° C. using the K10ST Wilhelmy plate method from Krüss.

### Viscosity

The viscosity of the curable compositions was measured using a DV II⁺ apparatus from Brookfield, model LVDV-II⁺, fitted with spindle SCA-18 rotated at 30 rpm. Measurements were performed at 25° C. and a sheer rate of 40 s⁻¹.

### Porosity

The average pore size (Mean Flow pore size) of the support was measured using a Porolux 1000 from Benelux Scientific, Belgium. The cell diameter was 25 mm, the test fluid Porefill 6. The average pore size of Viledon Novatexx F0 2426 was 52 μm.

### Surface Energy

Surface treated, polyester non-woven, porous membrane supports S1 to S6 and untreated porous support S7, as described in Table 1 below, were obtained from Freudenberg, Weinheim, Germany under the trade name Viledon Novatexx series. The surface energies were measured by the Fowkes method to an accuracy of +/−approximately 10%.

TABLE 1

| | | | | Air | Surface |
|---|---|---|---|---|---|
| Porous | Weight | Thickness | Density | permeability @ | Energy |
| Support | GSM | μm | kg/m³ | 2 mbarL/m² · s | mN/m |
| S1 | 60 | 120 | 500 | 750 | 10.1 |
| S2 | 80 | 110 | 727 | 400 | 12.4 |
| S3 | 100 | 160 | 625 | 250 | 13.5 |
| S4 | 60 | 120 | 500 | 750 | 3.2 |
| S5 | 80 | 110 | 727 | 400 | 7.4 |
| S6 | 60 | 120 | 500 | 750 | 2.7 |
| S7 | 60 | 120 | 500 | 750 | not |
| | | | | | determined |

Note:
The above data other than surface energy were as provided by the supplier.

Note: The above data other than surface energy were as provided by the supplier.

The density was calculated from the weight and the thickness. S1 to S5 had been subjected by the supplier to a plasma treatment in conjunction with a silicon compound (S1, S2 and S3) or a fluoro compound (S4 and S5). S6 had been subjected to a wet chemical treatment with a fluoro compound. S7 had not been subjected to any special treatment. The contact angle of the porous supports was determined using a VCA-2500XE Contact Angle Surface Analysis System from AST Products Inc. The contact angle was measured from a photo taken within 2 seconds, mostly within 1 second, after applying the droplet of liquid to the support. The surface energy was calculated using the Fowkes method as presented in the software program prop Shape Analysis (DSA) for Windows, Version 1.90.0.13 from Krüss. In this method, the four single-component liquids described in Table 2 were used to determine the surface energy of porous supports S1 to S7. The contact angle values <5 indicate complete wetting. For the calculation of the surface energy these values were not taken into account meaning that the calculation was done with 3 or 4 liquids. For the calculation for samples S4, S5 and S6 four liquids were used, for S1, S2 and S3 three liquids.

TABLE 2
Contact angle measurements for several liquids and several substrates

| | Surface | Surface | Surface | | | | | | | |
|---|---|---|---|---|---|---|---|---|---|---|
| | tension | tension | tension | | | | | | | |
| | (total) | (dispersive) | (polar) | Contact angle (±2°) | | | | | | |
| Liquid | (mN/m) | (mN/m) | (mN/m) | 1 | 2 | 3 | 4 | 5 | 6 | 7 |
| Water | 72.8 | 22.1 | 50.7 | 115 | 119 | 120 | 132 | 110 | 125 | 94 |
| Diiodomethane | 50.8 | 48.5 | 2.3 | 97 | 89 | 91 | 118 | 108 | 131 | 2 |
| Ethylene glycol | 48.0 | 29.0 | 19.0 | 97 | 110 | 90 | 125 | 110 | 130 | 2 |
| Dodecane | 25.1 | 25.1 | 0 | <5 | <5 | <5 | 108 | 87 | 104 | 2 |

Contact angles of 10° and lower indicated that the liquid wetted the porous support and penetrated it almost instantly. Contact angles above 90° indicated poor wetting (i.e. the liquid encountered a repulsive force delaying penetration). The strongest repulsion was obtained with porous supports S4 and S6, while the untreated support S7 showed the least repulsive force.

### Example 1

### (a) Preparation of Compositions

Compositions CC1 and CC2 were prepared by mixing the ingredients shown in Table 3.

TABLE 3

Quantity (wt %)

| Ingredient | CC1 | CC2 |
|---|---|---|
| DMAPAA | 49.35 | 49.35 |
| SR-833S | 49.35 | 49.35 |
| Irgacure ™ 1870 | 1.0 | 1.0 |
| Zonyl ™ FSN-100 | 0.3 | 0 |
| Zonyl ™ FSO | 0 | 0.3 |

### Notes:

DMAPAA is dimethylaminopropyl acrylamide, a curable compound having one acrylic group and a weakly basic group, obtained from Kohjin Chemicals, Japan.

SR-833S is tricyclodecane dimethanol diacrylate from Sartomer, France.

Irgacure™ 1870 is a photoinitiator obtained from Ciba Specialty Chemicals, Switzerland.

Zonyl™ FSN-100 is a water-soluble ethoxylated nonionic fluoro surfactant from DuPont, USA.

Zonyl™ FSO is a sparingly water-soluble ethoxylated nonionic fluoro surfactant from DuPont, USA.

Compositions CC1 and CC2 had a surface tension of 34.8 and 33.8 mN/m respectively, as measured by the K10ST Wilhelmy plate method from Krüss.

The viscosity and surface tension of CC1 and CC2 were measured using the techniques described above. The results are shown in Table 4 below:

TABLE 4

| | Viscosity (mPa · s) | |
|---|---|---|
| Liquid | at 25° C./40 s⁻¹ | Surface tension (mN/m) |
| Composition CC1 | 33 | 34.8 |
| Composition CC2 | 34 | 33.8 |

(b) Relationship Between Surface Tension (“ST”) and Surface Energy (“SE”) for CC1 and CC2 relative to Each Porous Support

The relationship between ST and SE for composition CC1 and CC2 respectively and porous supports is shown in Tables 5 and 6 below. “Comp.” Means comparative Example where ST-SE is less than 25 mN/m

TABLE 5
(using CC1)

| Example | ST (mN/m) | Substrate | SE (mN/m) | ST − SE (mN/m) |
|---|---|---|---|---|
| 1 | 34.8 | S4 | 3.2 | 31.6 |
| 2 | 34.8 | S5 | 7.4 | 27.4 |
| 3 | 34.8 | S6 | 2.7 | 32.1 |
| Comp. 1 | 34.8 | S1 | 10.1 | 24.7 |
| Comp. 2 | 34.8 | S2 | 12.4 | 22.4 |
| Comp. 3 | 34.8 | S3 | 13.5 | 21.3 |
| Comp. 4 | 34.8 | S7 | — | — |

TABLE 6
(using CC2)

| Example | ST (mN/m) | Substrate | SE (mN/m) | ST − SE (mN/m) |
|---|---|---|---|---|
| 4 | 33.8 | S4 | 3.2 | 30.6 |
| 5 | 33.8 | S5 | 7.4 | 26.4 |
| 6 | 33.8 | S6 | 2.7 | 31.1 |
| Comp. 5 | 33.8 | S1 | 10.1 | 23.7 |
| Comp. 6 | 33.8 | S2 | 12.4 | 21.4 |
| Comp. 7 | 33.8 | S3 | 13.5 | 20.3 |
| Comp. 8 | 33.8 | S7 | — | — |

(c) Step (i)—Applying CC1 to the Porous Supports

Composition CC1 was applied continuously to a moving porous support by means of a manufacturing unit comprising a composition application station, an irradiation source for curing the composition, a membrane collecting station and a means for moving the support from the composition application station to the irradiation source and to the membrane collecting station (backing rollers). The composition application station comprised a two-slot, multilayer slide bead coater. The same composition was applied through each of the two slots to give a coating on the porous support having a wet thickness of 100 μm.

(d) Step (ii)—Viscosity Increase

The supports carrying the composition CC1 were passed under a Light-Hammer™ LH6 UV curing device from Fusion UV Systems at a speed of 30 m/min, applying 100% intensity of the installed UV-lamp (D-bulb). This curing device was located downstream relative to the composition application station. The curing device caused the viscosity of the composition to increase to above 30,000 mPa·s within 6 seconds.

### (e) Results

The cured composition CC1 formed a layer on the porous supports of thickness 80-90 μm, as determined by scanning electron microscopy.

The cured composition was found to adhere very well to the porous supports and no delamination was observed. Furthermore, in Examples 1 to 3 for which the surface energy is at least 25 mN/m lower than the surface tension of the composition, the aforementioned backing rollers were not wetted or polluted by the composition. On the other hand, in Comparative Examples 1 to 4 the backing rollers were polluted with composition CC1.

Detailed results are as shown in Table 7 below:

TABLE 7

| Example | Substrate | Results |
|---|---|---|
| 1 | S4 | The top layer was glossy and defect-free. |
| 2 | S5 | The top layer was glossy and defect-free. |
| 3 | S6 | No penetration, uniform top layer. |
| Comp. 1 | S1 | locally penetrated in spots, no uniform top layer |
| Comp. 2 | S2 | locally penetrated in spots, no uniform top layer |
| Comp. 3 | S3 | somewhat locally penetrated in spots, almost |
| | | uniform top layer |
| Comp. 4 | S7 | immediate and complete penetration, no uniform |
| | | top layer and severe pollution of backing rollers |

Results of Example 1 (composition CC1) as ion exchange membrane are given in Table 8:

TABLE 8

| | | Electrical resistance | Surface Energy |
|---|---|---|---|
| Example | Permselectivity (%) | (ohm/cm²) | (mN/m) |
| 1 | 90.2 | 3.2 | 50.7 |

The surface energy of the composite membrane was calculated using three liquids (water, diiodomethane and ethylene glycol).

1.-29. (canceled)

30. A process for preparing a composite membrane comprising the steps of:
(i) applying to a porous support having an average surface energy of 1 to 30 mN/m a composition having a viscosity of 1 to 5,000 mPa·s; and
(ii) increasing the viscosity of the composition to a value higher than 30,000 mPa·s within 30 seconds after the composition has been applied to the support;
wherein the composition applied in step (i) has a surface tension that is at least 25 mN/m higher than the average surface energy of the porous support.

31. A process according to claim 30 wherein the composition has a surface tension that is 25 to 35 mN/m higher than the average surface energy of the porous support.

32. A process according to claim 30 wherein the porous support has an average surface energy of 2 to 10 mN/m.

33. A process according to claim 31 wherein the porous support has an average surface energy of 2 to 10 mN/m.

34. A process according to claim 30 wherein the composition is a curable composition and the increase in viscosity is achieved by a process comprising curing the composition.

35. A process according to claim 30 wherein the porous support used in step (i) is a porous support which has been treated with a fluoro compound and/or a silicon compound.

36. A process according to claim 30 wherein the composition has a surface tension that is 25 to 35 mN/m higher than the average surface energy of the porous support, the porous support has an average surface energy of 2 to 10 mN/m, the composition is a curable composition and the increase in viscosity is achieved by a process comprising curing the composition and the porous support used in step (i) is a porous support which has been treated with a fluoro compound and/or a silicon compound.

37. A process according to claim 30 wherein the porous support used in step (i) has been treated using a wet-chemical or plasma coating technique.

38. A process according to claim 36 wherein the porous support used in step (i) has been treated with heptadecafluorodecylacrylate (HDFDA), heptadecafluorodecene (HDFD) or a mixture comprising HDFDA and HDFD.

39. A process according to claim 37 wherein the porous support used in step (i) has been treated with heptadecafluorodecylacrylate (HDFDA), heptadecafluorodecene (HDFD) or a mixture comprising HDFDA and HDFD.

40. A continuous process according to claim 30 which is performed using a manufacturing unit comprising:
a composition application station,
an irradiation source for increasing the viscosity of the composition,
a membrane collecting station, and
a means for moving the support from the composition application station to the irradiation source and to the membrane collecting station, wherein the curable composition is applied to the support moving at a speed of over 10 m/min.

41. A process according to claim 30 wherein the air permeability of the support is below 3,000 L/m².s, measured at a pressure of 200 Pa.

42. A composite membrane comprising a porous support having an average surface energy of 1 to 15 mN/m, as measured prior to coating, and a polymeric layer in contact therewith having an average surface energy of at least 30 mN/m and comprising cured ethylenically unsaturated compounds.

43. A composite membrane according to claim 42 wherein the porous support has an average surface energy of 2 to 10 mN/m.

44. A composite membrane according to claim 42 wherein the membrane has a water permeability at 20° C. lower than 1×10⁻⁷ m³/m².s.kPa.

45. A composite membrane according to claim 42 wherein the polymeric layer comprises anionic and/or cationic groups.

46. A composite membrane according to claim 42 wherein the porous support has an average surface energy of 2 to 10 mN/m, the membrane has a water permeability at 20° C. lower than 1×10⁻⁷ m³/m².s.kPa and the polymeric layer comprises anionic and/or cationic groups.

47. An electro-deionisation unit comprising:
an ion-concentrating compartment,
an ion-depleting compartment,
an anode,
a cathode, and
ionically charged membranes separating the said compartments, or an electrodialysis or reverse electrodialysis unit, a flow through capacitor, a fuel cell, a diffusion dialysis apparatus or a membrane electrode assembly comprising one or more membranes, characterised in that at least one of the membranes is obtained by a process according to claim 30.

48. An electro-deionisation unit comprising an ion-concentrating compartment, an ion-depleting compartment, an anode, a cathode and ionically charged membranes separating the said compartments, or an electrodialysis or reverse electrodialysis unit, a flow through capacitor, a fuel cell, a diffusion dialysis apparatus or a membrane electrode assembly comprising one or more membranes, characterised in that at least one of the membranes is a composite membrane according to claim 42.

49. An electro-deionisation unit comprising an ion-concentrating compartment, an ion-depleting compartment, an anode, a cathode and ionically charged membranes separating the said compartments, or an electrodialysis or reverse electrodialysis unit, a flow through capacitor, a fuel cell, a diffusion dialysis apparatus or a membrane electrode assembly comprising one or more membranes, characterised in that at least one of the membranes is a composite membrane according to claim 46.

50. A process for the purification of water comprising the removal of dissolved ions with the composite membrane according to claim 42.

51. A process for the purification of water comprising the removal of dissolved ions with the composite membrane according to claim 46.

52. A process for the generation of electricity by reverse electrodialysis wherein electricity is generated from two streams differing in salt concentration separated by the composite membrane according to claim 42.

53. A process for the generation of electricity by reverse electrodialysis wherein electricity is generated from two streams differing in salt concentration separated by the composite membrane according to claim 46.
